(19) United States
(12) Patent Application Publication
(10) Pub. No.: US 2012/0311459 A1
(43) Pub. Date: Dec. 6, 2012

(54) FACILITATED CONTENT ITEM TRANSFER

(75) Inventor: James Prudente, Seattle, WA (US)

(73) Assignee: DASHWIRE INC., Seattle, WA (US)

(21) Appl. No.: 13/482,823

(22) Filed: May 29, 2012

Related U.S. Application Data
(60) Provisional application No. 61/492,730, filed on Jun. 2, 2011.

(51) Int. Cl. G06F 15/16; G06F 3/01

(52) U.S. Cl. 715/748; 709/204

(57) ABSTRACT

Embodiments of methods, systems, and storage medium associated with content transfer between computing devices are disclosed herein. In one instance, the method may include a computing device providing a first session identifier to a first computing device; receiving a second session identifier from a second computing device; determining whether to establish a communication connection between the first and second computing devices, based at least in part on the first and second session identifiers; establishing the communication connection between the first and second computing devices based on the result of the determination; and in response to receiving, from the first computing device, an indication of an intent to transfer a content item, facilitating transfer of the content item from the first computing device to the second computing device via the communication connection. Other embodiments may be described and/or claimed.

### CROSS-REFERENCE

This application claims priority from provisional U.S. Application No. 61/492,730 filed Jun. 2, 2011, which is hereby incorporated by reference in its entirety.

### TECHNICAL FIELD

Embodiments of the present invention relate to networked interaction between electronic devices, and in particular to facilitating file transfer between devices over a network.

### BACKGROUND

Creating a connection between two or more devices and moving content from one device to another can be a challenge. This challenge can be particularly noticeable in the context of mobile devices. For example, a user may want to move music, Microsoft Word or Excel files, and/or a number of photos from his or her computer to a mobile device, such as a smartphone, tablet, or other device. In existing systems, the user may either connect a USB cable and use software on his or her computer, or manually upload files to a networked storage drive. Use of a networked drive may require a user to create an account username and password so that the user can later access and download the files from the mobile device, such as by syncing the device with the networked drive.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 is a block diagram illustrating components of a facilitated file-transfer system in accordance with some embodiments.

FIG. 2 illustrates an environment in which various embodiments described herein may be practiced in accordance with some embodiments.

FIG. 3 is a flowchart illustrating an exemplary process for transferring content from a first computing device to a second computing device facilitated by the content transfer facilitator service in accordance with some embodiments.

FIG. 4 is a flowchart illustrating an exemplary process for receiving content items at a second computing device that are transferred from a first computing device-via the content transfer facilitator service in accordance with some embodiments.

FIG. 5 illustrates an environment in which various embodiments may be implemented in accordance with some embodiments.

### DETAILED DESCRIPTION

Embodiments described herein are directed to methods, apparatuses, and computer-readable media for facilitating content items (e.g., files) transfer over a network between two or more network connected devices. Method and systems described herein facilitate establishing a connection between devices and streaming content from one local memory store on a device to another local memory store on a device.

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents. Likewise, illustrated implementation details are not intended to demonstrate any particular requirements or limitations of embodiments described herein, but are instead offered merely as examples of the described embodiments.

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in embodiments,” which may each refer to one or more of the same or different embodiments. The description may also use the phrases “in an implementation,” or “in an alternative implementation,” which may each refer to one or more of the same or different implementation details of various embodiments described herein. Furthermore, the terms “comprising,” “including,” “having,” and the like, as used with respect to embodiments or implementations, are synonymous. The term “exemplary” is used herein merely illustrates that an example is being shown or described and is not intended to denote that any so-described feature is preferred, required, or necessarily presents particular advantages over any other. While flowcharts and descriptions of processes may make reference to particular steps or actions, it should be understood that, in alternative implementations, the illustrated steps may be combined or divided into two or more sub-steps. Also, while block diagrams may illustrate particular entities, blocks, or modules, it should be understood that, in alternative implementations, the illustrated entities, blocks, or modules may be combined, divided, or removed, and that additional entities, blocks, or modules may be utilized.

The present invention includes, in various embodiments, a Web service and a client application that enable content to be sent from one computing device (e.g., a computer under control of a user) to another computing device (e.g., a mobile device) under control of the user. A Web service may reside on a server and provide a Web-based application (e.g., a Web page) to one computing device. The client application may be provided to another computing device (e.g., a mobile device).

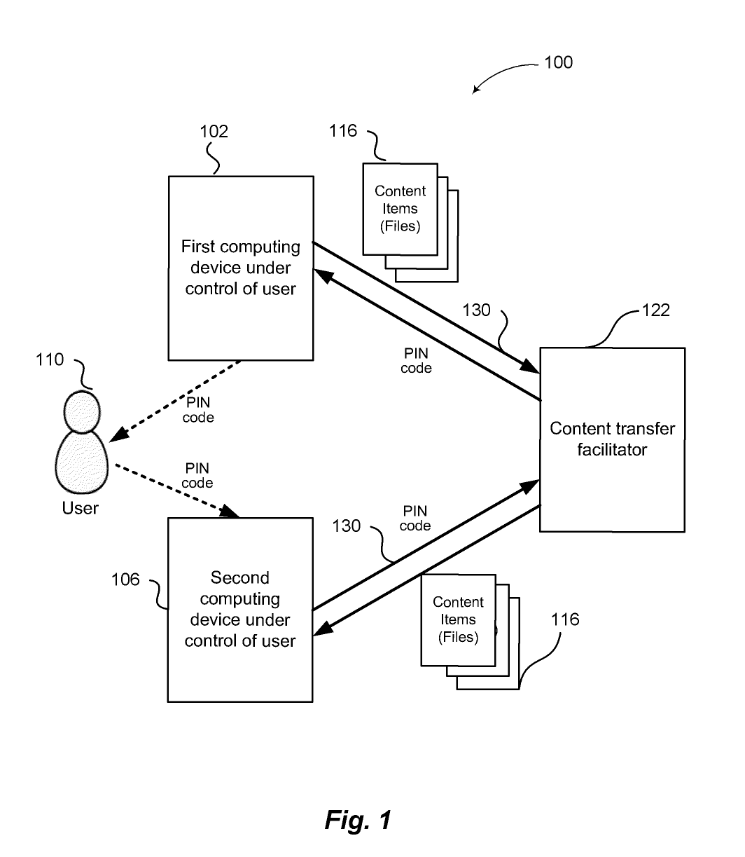

FIG. 1 is a block diagram illustrating components of a facilitated content transfer system 100, in accordance with various embodiments described herein. As FIG. 1 illustrates, a content transfer facilitator service 122 may interact with a first computing device 106 (e.g., a laptop or desktop computer) and a second computing device 116 (e.g., mobile device) under control of a user 110. In various embodiments, the content transfer facilitator service 122 may operate on a computer or server as described herein. In various embodiments, the content transfer facilitator service may provide a content transfer session identifier (e.g., PIN code) to the user through the computer under control of the user. In various embodiments, the PIN code may be provided through a Web-based interface that the user visits on the computer using a Web browser.

After the user 110 receives the content transfer session identifier (e.g., PIN code) using computer 102, the user 110 may input the PIN code into the mobile device 106. In various embodiments, the user 110 my input the PIN code, and otherwise interact with the mobile device 106, though a client application, such as a native app or Web-based application described below in greater detail. After the user inputs the PIN code into the client application on the mobile device 106, the mobile device 106 may send the PIN code to the content transfer facilitator service 122. In various embodiments, the PIN code may be manually inputted into the client application on the mobile device 106 or facilitated by the user, via a personal network or near field communication connection between computing device 102 and mobile device 106.

After receipt of the PIN code, the content transfer facilitator 122 may create a conduit 130 for content transfer between the computing device 102, where the user 110 received the PIN code, and the mobile device 106, where the user entered the PIN code. The content transfer facilitator service 122 may then facilitate transfer of one or more files 116 over this conduit 130, where they may be saved on a file system of the mobile device 106. In various embodiments, the files may be transferred by providing the files through a Web-based interface, such as by dragging-and-dropping the files into the interface or by otherwise selecting the files for transfer. In various embodiments, the files may be broken up before or during transfer, or may be broken into different pieces between the computer and the content transfer facilitator than in between the content transfer facilitator and the mobile device.

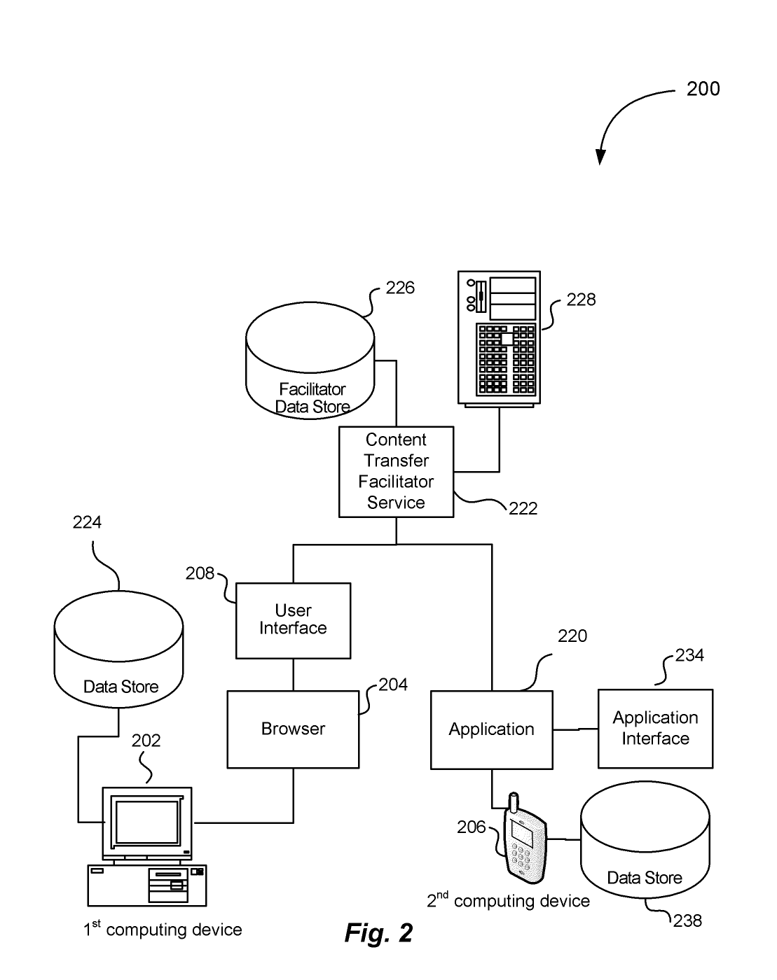

FIG. 2 shows an illustrative environment 200 in which the aspects of content transfer from a first computing device to a second computing device described herein may be implemented in accordance with some embodiments. In an embodiment, the environment 200 of FIG. 2 may be utilized to facilitate content transfer from a first computing device 202 to a second computing device 206 using content transfer facilitator service 222 provided by a Web server 228. It is to be understood that the content transfer facilitator service 222 may comprise a number of various implementations, including, but not limited to, a software application component executed on a computing device, such as the first computing (client) device 202 or the server 228. In one embodiment, the service 222 may be offered as a part of remote computing services that together make up a cloud computing platform, offered over the Internet. The service may be configured to run in a Web server environment, such as a pure Java HTTP (e.g., HTTP 5) Web server environment.

In an embodiment, the environment 200 may include the first (e.g. client) computing device 202 utilized by a user for interaction with electronic entities that provide content. Content may be accessed by the device 202 through the browser 204. The content may be stored in one or more remote or local content data stores 224, 226 and may be utilized by merchants, Web sites, or other entities in order to provide users an opportunity to search for, and view, content, for example, through a Web server 228. The data stores may be accessible (e.g., with a search engine) through the Internet or any other type of computer network known in the art.

In an embodiment, the content transfer facilitator service 222, operating on the server 228, may be configured to provide a Web-based service with a user interface 208 (e.g., a Web page) to the first computing device 202. The service 222 may provide a first content transfer session identifier to the first computing device 202 via the user interface 208. The service 222 then may receive another (second) session identifier from the second computing device 206 via an application 220 associated with the service 222 and executing on the device 206. The second session identifier may be input by the user in control of the device 206 via the application's interface 234. For example, the user may view the first session identifier delivered by the service 222 to the user interface 208 rendered on the first computing device 202 and may enter the viewed identifier (e.g., PIN code) into the application interface 234.

The service 222 may determine whether to establish a communication connection between devices 202 and 206. Such determination may include determining whether the first session identifier (e.g., one provided to the first computing device 202) matches the second session identifier provided to the service 222 by the second computing device 206 via the application 220. In alternate embodiments, the matching may be determined based on whether one identifier is a deterministic variant or transformation of the other. If a match is determined, the communication connection enabling content transfer from the device 202 to the device 206 may be established by the service 222. A user of the first device 202 may indicate, via the user interface 208, that there are one or more content items (e.g., audio, video, text, or other data files) to be transferred to the second device 206. Such indication may be provided, for example, by dragging and dropping file identifiers in a designated area of the user interface 208. In response, the service 222 may initiate transfer of the indicated content items to the device 206 via the communication connection. In an embodiment, the service 222 may store the content items that are being transferred in a data store 226 associated with the service 222.

The transferred files may be stored in a data store 238 associated with the second computing device 206. An indication of an established communication connection may be provided by the service 222 to either device 202 and 206. For example, a color of the interface 208 and application 234 may change (e.g., from red to green) to indicate that the communication connection between two devices has been established.

In an embodiment, the content transfer facilitator service 222 may be implemented as a trusted script, for example, a JavaScript®. In some embodiments, the trusted script may also be implemented as ActionScript®, VBScript®, Java Servlet®, Flash®, JScript® or other scripting languages. In some embodiments, the trusted script may be implemented as an extension (i.e., a plug-in application) to the browser 204. In some embodiments, the trusted script may be loaded on a page of the Web-based application provided to the first computing device 202. In general, the trusted script 222 does not have to be Web site-specific; the script may be provided as a part of a browser or be installed as an extension to a browser.

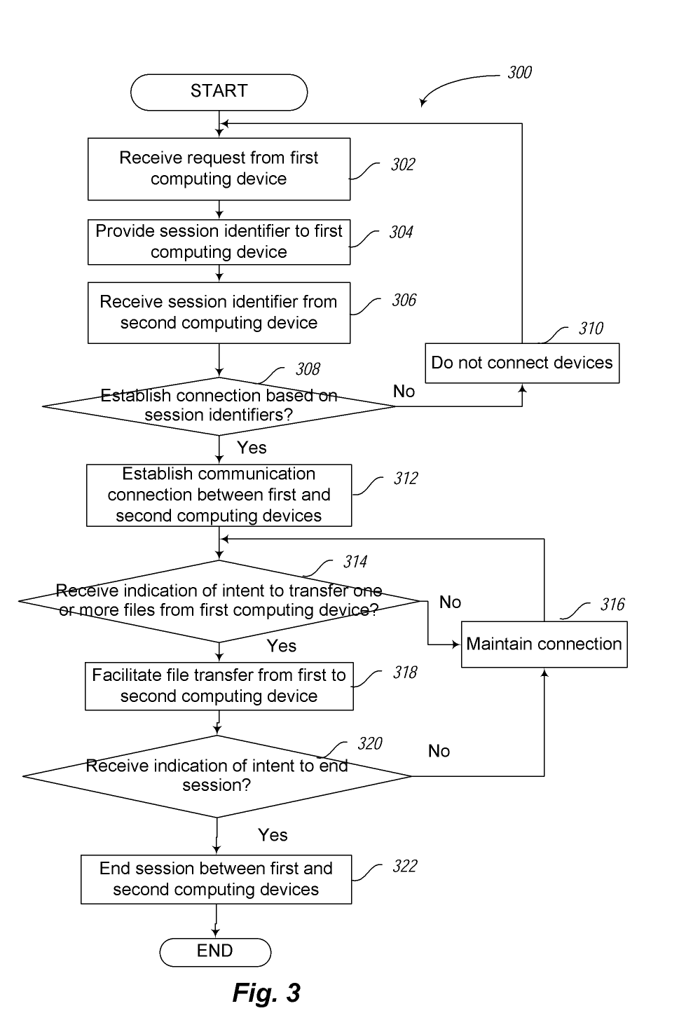

FIG. 3 is a flowchart illustrating an exemplary process 300 for transferring content in accordance with various embodiments described herein. While the example of FIG. 3 is described in the context of transferring content items (e.g., files) from a computer to a mobile device, in other embodiments files may be transferred from a mobile device to another mobile device, from a mobile device to a standalone computer, between two computers, or between other combinations of computing devices. Additionally, in various embodiments, the communications performed by the various devices and entities in FIG. 3 may be performed over the Internet, a mobile phone network, and/or other types of wired or wireless networks.

The process 300 may begin at block 302, where a content transfer facilitator service may receive a request from a first computing device (e.g., a laptop or desktop computer) to connect with a second computing device (e.g., another computer or mobile device). For example, such request may be initiated when a user visits an interface, such as a Web page, provided by the content transfer facilitator service to the first computing device, for transferring files to another device. User accessing the Web page may initiate a response from the content transfer facilitator service. The response may include providing a content session transfer identifier to the user via the Web page rendered by the first computing device (block 304). For example, the service may provide a PIN code to the user to be displayed on the Web page. The session identifier may also be associated with a particular session shared token which identifies a particular content transferring session taking place.

Next, the user may input the provided PIN code into a second computing device (e.g., mobile device), such as by entering it into a mobile client (application) executing on the mobile device via an application interface. For example, the interface may have several boxes into which the digits of a PIN code may be input. In one embodiment, the application may be provided by, or be associated with, the content transfer facilitator service. The mobile device may then transmit the PIN code to the content transfer facilitator service, which may be received by the content transfer facilitator service at block 306.

At decision block 308, the content transfer facilitator service may determine whether a connection between the first and second computing devices may be established. The content transfer facilitator service may determine whether the session identifier (PIN code) received from the second device (e.g., mobile device) matches the session identifier (PIN code) issued by the content transfer facilitator service at block 306. For example, the content transfer facilitator service may receive from the second computing device a session shared token associated with the session identifier that matches the token that was earlier sent to the first computing device. As described earlier, matching may be based on exact match or deterministic variant or transformation. If no match found, at block 310 a connection between the computing devices may not be established and the process 300 moves back to block 302. If a match is determined, the communication connection may be established between the devices at block 312.

Next, the user may indicate that one or more content items (e.g., files) are to be transferred to the mobile device. In one embodiment, the user may perform this indicating by dragging the file visual identifiers (e.g., icons or other visual identifiers) from an operating system interface into the Web-based interface provided by the content transfer facilitator service. In other embodiments, different methods of indication of content items to be transferred may be used. Accordingly, at decision block 314, it may be determined whether such indication is received by the content transfer facilitator service. If no indication about content items to be transferred is received, at block 316 the communication connection between first and second computing devices is maintained and the process 300 moves back to block 314 to wait until the indication of content items to be transferred may be received.

If the content items to be transferred have been indicated, at block 318 the content transfer facilitator service may facilitate transmission of the content items from the first computing device to the second computing device. In various embodiments, the content items may be transferred in whole or in parts. For example, the content items may be transferred to the content transfer facilitator service from the first computing device in segments. Each segment may be buffered by the service and transferred to the second computing device upon receipt of the next content item segment, which then may be buffered, and so on. Accordingly, a streaming-like effect of the transmission of a content item from the first computing device to the second computing device may be accomplished. In some embodiments, a secure channel may be used to transmit the content items. In various embodiments, the content transfer facilitator service may throttle the rate of transmission of the content items, based on available resources or bandwidth, and may ask the computer to pause or slow transmission at times.

At decision block 320 it may be determined whether an indication to end the transfer session (e.g., communication connection between the first and second computing devices) is received. For example, a user may select a user interface selectable element on the first or second computing devices that, when selected, executes a message to the service to end the session. For example, the user may select a button “End Session” rendered with the Web-based interface on the first computing device by the content transfer facilitator service. Alternatively, the user may provide such indication on the second computing device (e.g., mobile device) via the application executing on the mobile device. If no such indication is received, the process 300 moves back to block 316. If it is determined that an indication to end the transfer session is received, at block 322 the communication connection between the first and second computing devices may be ended.

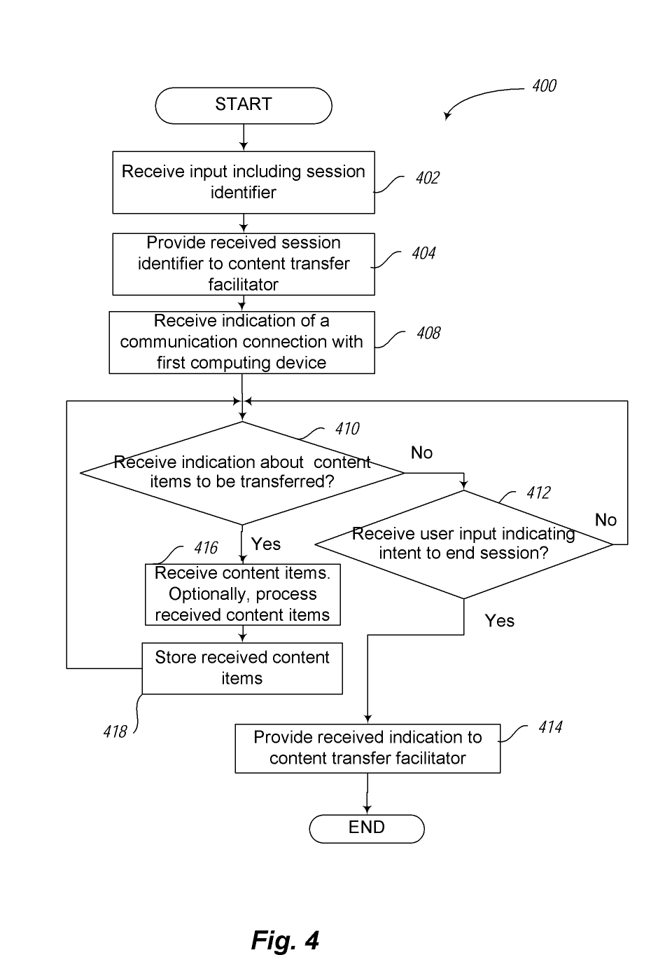

FIG. 4 is a flowchart illustrating an exemplary process 400 for receiving content items at a second computing device (e.g., a mobile device) that are transferred from a first computing device (e.g., a laptop, a desktop, or the like) via the content transfer facilitator service in accordance with an embodiment. The process 400 may be implemented by an application associated with the content transfer facilitator service and that may be residing either on the computing device or a server providing the content transfer facilitator service. In an embodiment, the application may execute on the second computing device (e.g., mobile device) and may be associated with the content transfer facilitator service.

The process 400 may begin at block 402, where a user input that includes session identifier may be received by the application executing on the mobile device. As described above, the user may enter the session identifier via the application's interface. The session identifier may be provided to the user via Web-based interface (e.g., Web page) associated with the content transfer facilitator service and rendered to the first computing device (e.g., laptop or desktop). At block 404, the received session identifier or information associated with the session identifier (e.g., session shared token generated by the content transfer facilitator service) may be provided by the application executing on the mobile device to the content transfer facilitator service.

At block 408, an indication of established communication connection with the first computing device may be received. For example, the content transfer facilitator service may confirm the connection based on the determination whether the received session identifier matches the generated session identifier as described above in reference to FIG. 3.

After the connection is established, the content transfer facilitator may initiate transmission of content items (files) or content item (file) segments to the mobile device upon detecting an indication that there are content items ready for transmission. For example, if the content transfer facilitator receives an indication about content items to be transferred (as described in reference to FIG. 3), the service may inform the application executing on the mobile device that the content items transfer is requested. Accordingly, at decision block 410 it may be determined whether an indication of a content item transfer is received from the content transfer facilitator service. In response, the application executing on the mobile device may inform the content transfer facilitator service about the readiness of the mobile device to receive content items.

Accordingly, if the indication about content items to be transferred is determined to have been received from the content transfer facilitator service, at block 416, the content items may be received at the mobile device. As with the transfer of content from the first computing device to the content transfer facilitator service, the transmission may, in various embodiments, be paused or slowed based on bandwidth or computing resources, and may be performed over a secure channel. As content items are received by the mobile device via the executing application, the application, optionally, may reassemble file segments as they are received and may write the content items to a local storage as indicated by block 418. After the content items are received, processed (e.g., assembled), and stored, the process may return to block 410 and wait until an indication of the next content item(s) transfer may be received from the content transfer facilitator service.

If at block 410 it is determined that no indication about content items to be transferred is received, the process may move to decision block 412, where it is determined whether user input indicating an intent to end the transfer session is received. If no such indication is received, the process moves to block 410. If such indication is received, at block 414 information indicating the user intent to end the transfer session may be provided to the content transfer facilitator service, which then may end the communication connection between the first and second computing devices as described above.

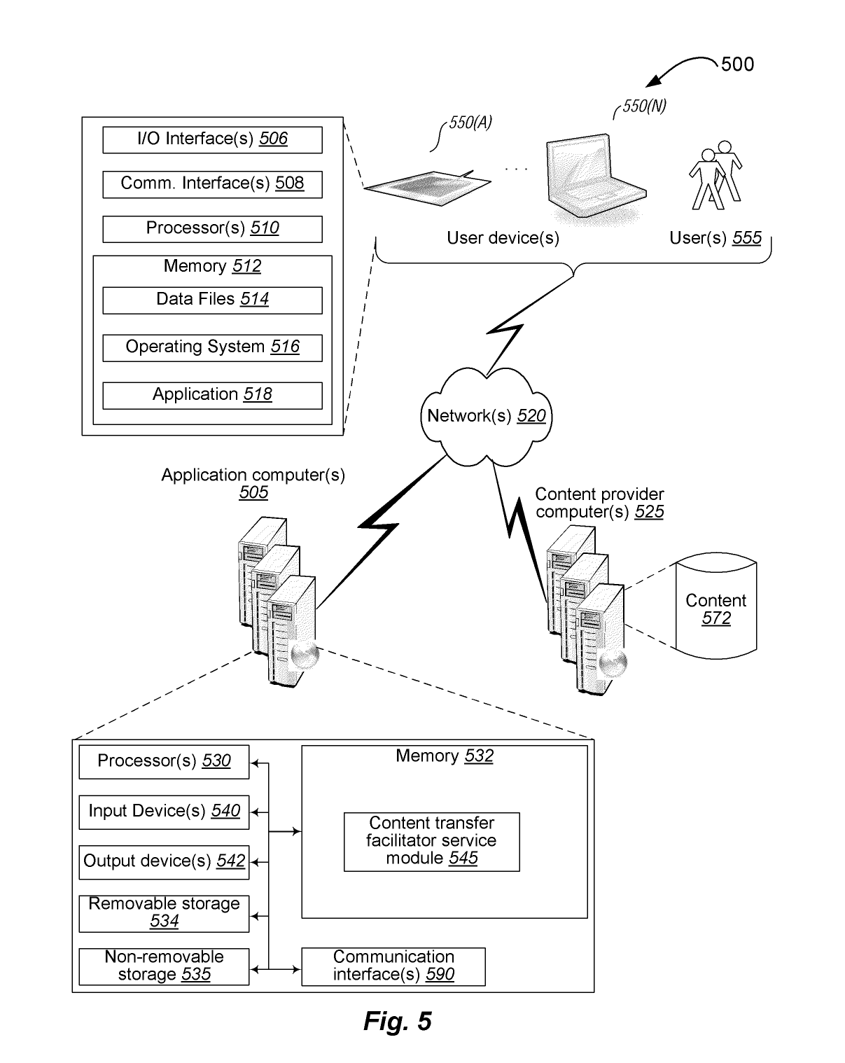

FIG. 5 illustrates an example of an environment 500 for implementing aspects of the facilitated content transfer in accordance with various embodiments. As will be appreciated, although a Web-based environment is used for purposes of explanation, different environments may be used, as appropriate, to implement various embodiments. The environment 500 includes one or more electronic client (user) devices 550(A)-550(N), which may include any appropriate device operable to send and receive requests, messages, or information over an appropriate network 520 and convey information back to a user 555 of the device. Examples of such client devices may include, but are not limited to, personal computers, cell phones, handheld messaging devices, laptop computers, set-top boxes, personal data assistants, electronic book readers, tablets, game consoles, mobile devices (e.g., smart phones) and the like. These devices may also include workstations running any of a variety of commercially available operating systems and other known applications for purposes such as development and database management. These devices may also include other electronic devices, such as dummy terminals, thin-clients, gaming systems, and other devices capable of communicating via a network. The user devices 550(A)-550(N) may include a processor 510 and memory 512 for storing processor-executable instructions, such as data files 514, operating system 516, and one or more applications 518, such as for example a browser or an application executing on a computing device (e.g., mobile device) to configure the device to transfer content items as described in reference to FIG. 3, and/or receive transferred content items as described in reference to FIG. 4.

The devices may further include at least one or both of the following elements: input/output interface 506 designed to enable peripheral component interaction with the system 500 and communication interface 508. In various embodiments, the input/output interface 506 may include, but is not limited to, a display, e.g., a liquid crystal display, a touch screen display, etc., a speaker, a microphone, a still camera, a video camera, a flashlight (e.g., a light emitting diode flash), and a keyboard. For embodiments including a display supporting touch screen features, the system 500 may include a touchscreen controller for facilitating control of the display.

The network 520 may include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network may be enabled by wired or wireless connections, and combinations thereof. In this example, the network includes the Internet, and the environment includes one or more Web servers (content provider servers) 525 for receiving requests and serving content in response thereto, although for other networks, an alternative device serving a similar purpose could be used, as would be apparent to one of ordinary skill in the art.

The illustrative environment 500 may include at least one application server (e.g., content transfer facilitator service server) 505 including, or associated with, one or more processors 530, input devices 540, output devices 542, removable storage 534, and non-removable storage 535 that may be connected to a communication interface 590 and memory 532. As discussed above, in one embodiment, a content transfer facilitator service may reside on the server 505 and may execute on a client device 550 or server 505. Accordingly, the memory 532 may include a content transfer facilitator service module 545.

Content that may be transferred between the client devices 550(A)-550(N) via the application server 505 may be provided by one or more content provider Web servers 525. The content data store 572 may be associated with the server 525. The data store 572 may be operable, through logic associated therewith, to receive instructions from the server 525 and obtain, update, or otherwise process data in response thereto.

Each server may include an operating system that provides executable program instructions for the general administration and operation of that server, and typically may include a computer-readable medium storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

The environment 500 may include a variety of data stores and other memory and storage media as discussed above. These may reside in a variety of locations, such as on a storage medium local to (and/or resident in) one or more of the computers or remote from any or all of the computers across the network. Any necessary files for performing the functions attributed to the computers, servers, or other network devices may be stored locally and/or remotely, as appropriate. The storage media may include non-transitory media such as disk drives, optical storage devices, and solid-state storage devices, such as random access memory (“RAM”) or read-only memory (“ROM”), flash memory or other memory technology, CD-ROM, digital versatile disk (DVD) or other optical storage, magnetic cassettes, magnetic tape, magnetic disk storage or other magnetic storage devices, as well as removable media devices, memory cards, flash cards, or any other medium which may be used to store the desired information and which may be accessed by a processor. By way of example, and not limitation, with the computing environment 500, computer-readable media may include memory 512, computer-readable storage media 535 (e.g., CDs, DVDs, diskettes, flash drives, removable hard drives, hard drive arrays), content data stores 572 and combinations of any of the above.

The environment 500 may be a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system 500 in FIG. 5 should be taken as being illustrative in nature, and not limited to the scope of the disclosure.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein.

The techniques and tools may be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description may use terms like “transmit,” “transfer,” and “send” to describe computer operations in a computing environment. These terms are high-level abstractions for operations performed by a computer, and should not be confused with acts performed by a human being. The actual computer operations corresponding to these terms vary depending on implementation.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended all matter contained in the above description shall be interpreted as illustrative and not in a limiting sense.

What is claimed is:

1. A computer-implemented method for facilitating content transfer between computing devices, the method comprising:
under control of one or more computer systems configured with executable instructions,
providing a first session identifier to a first computing device;
receiving a second session identifier from a second computing device;
determining whether to establish a communication connection to communicatively couple the first and second computing devices, based at least in part on the first and second session identifiers;
establishing the communication connection that is communicatively coupling the first and second computing devices based at least in part on an affirmative result of the determining, the communication connection enabling a content transfer from the first computing device to the second computing device; and
in response to receiving, from the first computing device, an indication of an intent to transfer a content item, facilitating transfer of the content item from the first computing device to the second computing device via the communication connection.

2. The computer-implemented method of claim 1, wherein facilitating the content transfer from the first to the second computing device includes:
informing the second computing device about the intent to transfer the content item;
receiving from the second computing device a notification that indicates that the second computing device is ready to receive the content item; and
in response to the notification,
receiving a segment of the content item to be transferred from the first computing device;
buffering the segment of the content item; and
transferring the segment of the content item to the second computing device after receiving another segment of the content item from the first computing device.

3. The computer-implemented method of claim 1, wherein facilitating the content transfer from the first to the second computing device further includes: controlling a speed of transfer of the content item by throttling, pausing, or slowing transmission rate of the content item based on available bandwidth of the communication connection.

4. The computer-implemented method of claim 1, further comprising: storing the content item at an associated data store.

5. The computer-implemented method of claim 1, further comprising:
receiving indication of intent to end the communication connection that is communicatively coupling the first and second computing devices; and
ending the communication connection.

6. The computer-implemented method of claim 1, wherein the first computing device is selected from: a laptop, a desktop, a notebook, a tablet PC, or a smart phone.

7. The computer-implemented method of claim 1, wherein the second computing device comprises a smart phone.

8. The computer-implemented method of claim 1, wherein the providing a first session identifier to a first computing device includes:
providing a Web-based service accessible to the first computing device, the Web-based service including a service user interface; and
rendering the first session identifier for display on the service user interface in response to an access of the Web-based the service via a Web browser executing on the first computing device.

9. The computer-implemented method of claim 8, wherein the receiving an indication of an intent to transfer a content item includes detecting a drag-and-drop input associated with a visual identifier of the content item, the drag-and-drop input resulting in placing the visual identifier in a designated area of the service user interface.

10. The computer-implemented method of claim 1, wherein the communication connection comprises a secure communication channel.

11. The computer-implemented method of claim 1, wherein the second session identifier is received within a determined time period after providing the first session identifier to the first computing device.

12. The computer-implemented method of claim 1, wherein the determining whether to establish a communication connection to communicatively couple the first and second computing devices includes determining whether the first session identifier matches the second session identifier.

13. A computer-implemented method for facilitating content transfer between computing devices, the method comprising:
under control of a second computing device configured with an application executing on the second computing device,
receiving, via a user interface associated with the application, user input including a session identifier;
providing information associated with the received session identifier to a content transfer facilitator service;
receiving, from the content transfer facilitator service, an indication of a communication connection with a first computing device associated with the content transfer facilitator service, the communication connection enabling a content transfer session associated with the session identifier, the content transfer session including content transfer from the first computing device to the second computing device; and
in response to receiving, from the content transfer facilitator service, a notification about one or more content items to be transferred,
receiving, from the content transfer facilitator service via the communication connection, the one or more content items provided by the first computing device; and
storing the received one or more content items.

14. The computer-implemented method of claim 13, wherein at least one of the one or more content items is provided in content segments, and wherein the method further includes:
processing the received one or more content items, the processing including assembling the one of the one or more content items based on the provided content segments.

15. The computer-implemented method of claim 13, further comprising:
receiving, via the user interface, user input indicating an intent to end the content transfer session enabled by the communication connection; and
providing information associated with the indicated intent to the content transfer facilitator service.

16. The computer-implemented method of claim 15, wherein the user input includes selecting a user interface element rendered on the user interface.

17. The computer-implemented method of claim 13, wherein the content items include at least one of a video, audio, or text content.

18. The computer-implemented method of claim 13, further comprising: rendering an indication of the communication connection to the user interface associated with the application, the indication including changing a color of the user interface.

19. The computer-implemented method of claim 13, further comprising:
in response to receiving, from the content transfer facilitator service, a notification about one or more content items to be transferred, informing the content transfer facilitator service about a readiness to receive the content items.

20. A computer system, comprising:
a server having a processor and a memory with executable instructions stored thereon that, when executed, cause the server to:
provide a Web-based application to a first computing device coupled with the server via a network;
provide a first session identifier to the first computing device via an interface of the Web-based application that is rendered by a browser executing on the first computing device;
receive a second session identifier from a second computing device coupled with the server via the network;
determine whether to establish a communication connection to communicatively couple the first and second computing devices, based at least in part on the first and second session identifiers;
establish the communication connection that is communicatively coupling the first and second computing devices based at least in part on an affirmative result of the determining, the communication connection enabling a content transfer from the first computing device to the second computing device; and
in response to receiving, from the first computing device, an indication of an intent to transfer a content item, facilitate transfer of the content item from the first computing device to the second computing device via the communication connection.

21. The computer system of claim 20, wherein the second computing device includes a second processor and a second memory having instructions stored thereon that, when executed on the second processor, enable an application that causes the second computing device to:
receive, via a user interface associated with the application, user input including the second session identifier;
provide information associated with the received second session identifier to the server;
receive, from the server, an indication of the communication connection with the first computing device; and
in response to receiving, from the server, a notification about one or more content items to be transferred,
receive, via the communication connection, the one or more content items provided by the first computing device; and
store the received one or more content items.

22. The computer system of claim 21, wherein the application is provided to the second computing device by the server.

23. The computer system of claim 21, wherein facilitating the content transfer from the first to the second computing device further causes the server to:
inform the second computing device, via the application executing on the second computing device, about the intent to transfer the content item;
receive, via the application executing on the second computing device, a notification that indicates that the second computing device is ready to receive the content item; and
in response to the notification,
receive a segment of the content item to be transferred from the first computing device;
buffer the segment of the content item; and
transfer the segment of the content item to the second computing device after receiving another segment of the content item from the first computing device.

24. The computer system of claim 21, wherein the application further causes the second computing device to:
receive, via the user interface, user input indicating an intent to end the initiated connection; and
provide information associated with the indicated intent to the server.

25. The computer system of claim 20, wherein the first computing device is selected from: a laptop, a desktop, a notebook, a tablet PC, or a smart phone.

26. The computer system of claim 20, wherein the second computing device is selected from: a laptop, a desktop, a notebook, a tablet PC, or a smart phone.

27. At least one computing device-readable storage medium having executable instructions stored thereon that cause a server computing device, in response to execution by the computing device, to enable the server computing device to:
provide a first session identifier to a first computing device;
receive a second session identifier from a second computing device;
determine whether to establish a communication connection to communicatively couple the first and second computing devices, based at least in part on the first and second session identifiers;
establish the communication connection that is communicatively coupling the first and second computing devices based at least in part on an affirmative result of the determining, the communication connection enabling a content transfer from the first computing device to the second computing device; and
in response to receiving, from the first computing device, an indication of an intent to transfer a content item, facilitate transfer of the content item from the first computing device to the second computing device via the communication connection.

28. At least one computing device-readable storage medium having executable instructions stored thereon that cause a computing device, in response to execution by the computing device, to enable the computing device to:
receive user input including a session identifier;
provide information associated with the received session identifier to a content transfer facilitator service associated with the computing device;
receive, from the content transfer facilitator service, an indication of a communication connection with another computing device associated with the content transfer facilitator service, the communication connection enabling a content transfer session associated with the session identifier, the content transfer session including content transfer from the computing device to the another computing device; and
in response to receiving, from the content transfer facilitator service, a notification about one or more content items to be transferred,
receiving, from the content transfer facilitator service via the communication connection, the one or more content items provided by the another computing device; and
storing the received one or more content items.
